(19) United States
(12) Patent Application Publication
(10) Pub. No.: US 2006/0042932 A1
(43) Pub. Date: Mar. 2, 2006

(54) Apparatus and method for electroplating a workpiece

(76) Inventors: Mark Alan Rosenzweig, Hamilton, OH (US); Michael Howard Rucker, Cincinnati, OH (US); John D. Evans SR., Springfield, OH (US)

Correspondence Address: DOUGLAS E. ERICKSON, 2000 COURTHOUSE PLAZA NE, P.O. BOX 8801, DAYTON, OH, 45401-8801, US

(21) Appl. No.: 10/925,649

(22) Filed: Aug. 25, 2004

(51) Int. Cl. B23H 3/02; C25D 21/12

(52) U.S. Cl. 204/230.2; 204/228.1; 204/229.4

(57) ABSTRACT

Apparatus for electroplating a workpiece includes a primary electroplating anode, an auxiliary electroplating anode, and a resistor. The resistor is electrically connected in series to one of the primary and auxiliary electroplating anodes. The primary and auxiliary electroplating anodes are electrically connectable in parallel to an electrolyte. A method for electroplating a workpiece includes obtaining an electrolyte, a primary electroplating anode, and an auxiliary electroplating anode. The workpiece and the primary and auxiliary electroplating anodes are positioned in contact with the electrolyte. Electric current is applied through the primary electroplating anode at a first amperage and through the auxiliary electroplating anode at a different second amperage.

### BACKGROUND OF THE INVENTION

The present invention relates generally to applying a coating on a workpiece, and more particularly to an apparatus and method for electroplating a workpiece.

It is known to coat turbine airfoils, such as turbine airfoils of an aircraft engine, with platinum aluminide diffusion coatings for protection against high temperature oxidation and corrosion. To develop the platinum aluminide coating, the parts are first platinum electroplated. It is known to use the electrolyte Pt(NH₃)₄HPO₄ for platinum electroplating turbine airfoils.

In a known electroplating method, a primary electroplating anode and an auxiliary electroplating anode are electrically connected in parallel to an anode fixture and the electrolyte. A cathode fixture is connected in series to, and supports, the workpiece which is in contact with the electrolyte. A voltage is applied across the anode fixture and the cathode fixture for electroplating the workpiece. However, some electrolytes, such as Pt(NH₃)₄HPO₄, are not well suited to achieving a uniform deposition over complex shapes.

Still, scientists and engineers continue to seek improved apparatus and methods for electroplating a workpiece.

### BRIEF DESCRIPTION OF THE INVENTION

A first expression of an embodiment of the invention is apparatus for electroplating a workpiece and includes a primary electroplating anode, an auxiliary electroplating anode, and a resistor. The resistor is electrically connected in series to one of the primary and auxiliary electroplating anodes. The primary and auxiliary electroplating anodes are electrically connectable in parallel to an electrolyte.

A first method of the invention is for electroplating a workpiece and includes several steps. One step includes obtaining an electrolyte, a primary electroplating anode, and an auxiliary electroplating anode. Another step includes positioning the workpiece and the primary and auxiliary electroplating anodes in contact with the electrolyte. Another step includes applying electric current through the primary electroplating anode at a first amperage and through the auxiliary electroplating anode at a different second amperage.

In one example of the first method and the first expression of an embodiment of the invention, the workpiece is a turbine nozzle doublet having two airfoils and having an inner band and an outer band each connecting together the two airfoils, the primary electroplating anode is positioned outward of the two airfoils, the auxiliary electroplating anode has at least a portion which is positioned between the two airfoils, and the resistance of the resistor is chosen to achieve a more uniform platinum deposition on inter-airfoil-facing surfaces of the two airfoils over that achieved in the absence of the resistor.

### BRIEF DESCRIPTION OF THE DRAWING

The accompanying drawing illustrates an embodiment of the invention wherein:

FIG. 1 is a schematic electrical-connection diagram of an embodiment of apparatus of the invention for electroplating a workpiece; and

FIG. 2 is a schematic front elevational view of a turbine airfoil doublet example of the workpiece of FIG. 1 together with the primary electroplating anode of FIG. 1 located outward of the two airfoils of the turbine airfoil doublet and with the auxiliary electroplating anode of FIG. 1 located between the two airfoils, and with the electrical connections and the remaining components of FIG. 1 omitted for clarity.

### DETAILED DESCRIPTION OF THE INVENTION

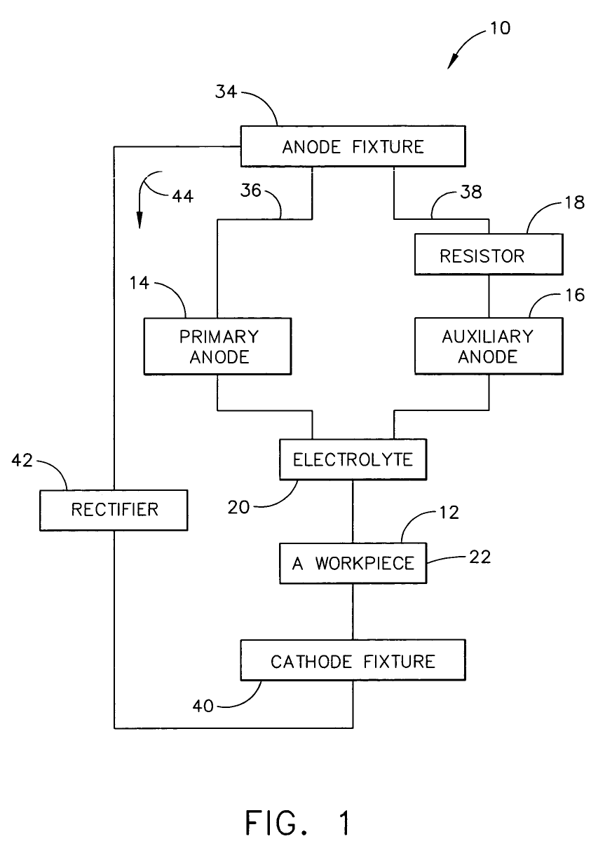

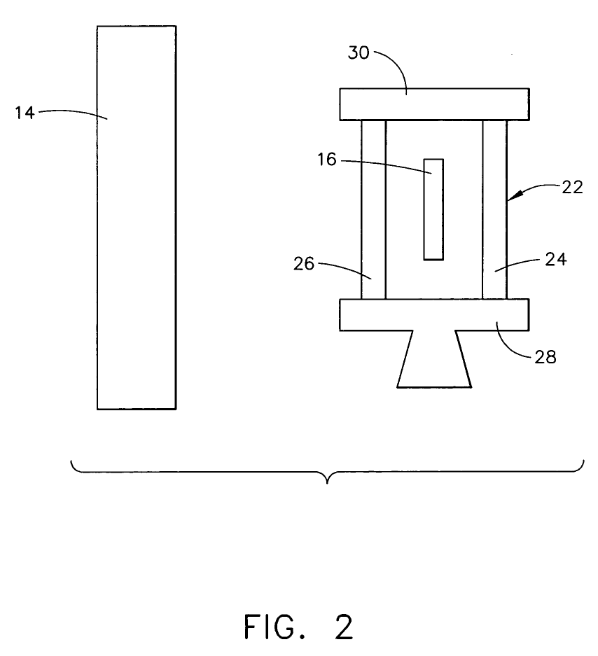

Referring now to the drawing, FIGS. 1-2 disclose an embodiment of the invention. A first expression of the embodiment of FIGS. 1-2 is apparatus 10 for electroplating a workpiece 12. The apparatus 10 includes a primary electroplating anode 14, an auxiliary electroplating anode 16, and a resistor 18. The resistor 18 is electrically connected in series to one of the primary and auxiliary electroplating anodes 14 and 16. The primary and auxiliary electroplating anodes 14 and 16 are electrically connectable (and in one arrangement electrically connected) in parallel to an electrolyte 20. It is noted that describing the apparatus as having a particular component (such as a primary electroplating anode) means that the apparatus has at least one particular component (such as at least one primary electroplating anode).

In one enablement of the first expression of the embodiment of FIGS. 1-2, the resistor 18 is electrically connected in series to the auxiliary electroplating anode 16. In the same or a different enablement, the workpiece 12 has a workpiece shape, and the auxiliary electroplating anode 16 has an auxiliary-anode shape which conforms at least in part to the workpiece shape. In one example, the workpiece is a turbine nozzle doublet 22 having two airfoils 24 and 26 and having an inner band 28 and an outer band 30 each connecting together the two airfoils 24 and 26. In one modification, the resistor 18 is a variable resistor. In a different modification, the resistor 18 is a fixed resistor.

A second expression of the embodiment of FIGS. 1-2 is apparatus 10 for electroplating a turbine nozzle doublet 22 having two airfoils 24 and 26 and having an inner band 28 and an outer band 30 each connecting together the two airfoils 24 and 26. The apparatus 10 includes a primary electroplating anode 14, an auxiliary electroplating anode 16, and a resistor 18. The primary electroplating anode 14 is disposable (and in one arrangement disposed) outward of the two airfoils 24 and 26. The auxiliary electroplating anode 16 has at least a portion which is disposable (and in one arrangement disposed) between the two airfoils 24 and 26. The resistor 18 is electrically connected in series to the auxiliary electroplating anode 16. The primary and auxiliary electroplating anodes 14 and 16 are electrically connectable in parallel to an electrolyte 20.

In one enablement of the second expression of the embodiment of FIGS. 1-2, the electrolyte 20 is disposed in contact with the two airfoils 24 and 26 and with the primary and auxiliary electroplating anodes 14 and 16. In one choice of materials, the electrolyte 20 comprises (and in one example consists essentially of) Pt(NH₃)₄HPO₄, In one modification, the resistor 18 is a variable resistor. In a different modification, the resistor 18 is a fixed resistor having a resistance chosen to substantially increase platinum deposition on inter-airfoil-facing surfaces of the two airfoils 24 and 26 over that in the absence of the resistor 18 and to avoid any substantial deposited platinum blistering. In one example, the portion of the auxiliary electroplating anode 16 which is disposable between the two airfoils has a shape of substantially a plate covered with an anode mesh (the electrochemically active portion of the auxiliary electroplating anode).

A first method of the invention is for electroplating a workpiece 12 and includes several steps. One step includes obtaining an electrolyte 20, a primary electroplating anode 14, and an auxiliary electroplating anode 16. Another step includes disposing the workpiece 12 and the primary and auxiliary electroplating anodes 14 and 16 in contact with the electrolyte 20. Another step includes applying electric current through the primary electroplating anode 14 at a first amperage and through the auxiliary electroplating anode 16 at a different second amperage.

In one employment of the first method, the workpiece 12 includes two spaced apart workpiece portions, wherein the primary electroplating anode 14 is disposed outward of the two spaced-apart workpiece portions, and wherein the auxiliary electroplating anode 16 has at least a portion which is disposed between the two spaced-apart workpiece portions. In one choice of materials, the electrolyte 20 comprises (and in one example consists essentially of) Pt(NH₃)₄HPO₄. In one variation, the second amperage is chosen to substantially increase platinum deposition on areas of the workpiece 12 between the two spaced-apart workpiece portions over that of equal first and second amperages and is chosen to substantially avoid deposited platinum blistering. In one employment of the first method, the workpiece 12 is a turbine nozzle doublet 22 having two airfoils 24 and 26 and having an inner band 28 and an outer band 30 each connecting together the two airfoils 24 and 26.

A second method of the invention is for electroplating a turbine nozzle doublet 22 having two airfoils 24 and 26 and having an inner band 28 and an outer band 30 each connecting together the two airfoils 24 and 26. The second method includes several steps. One step includes obtaining an electrolyte 20 comprising (and in one example consisting essentially of) Pt(NH₃)₄HPO₄. Another step includes obtaining a primary electroplating anode 14, an auxiliary electroplating anode 16, a resistor 18, and an anode fixture 34. Another step includes disposing the two airfoils 24 and 26 and the primary and auxiliary electroplating anodes 14 and 16 in contact with the electrolyte 20. Another step includes creating a circuit having two branches 36 and 38 in parallel electrical connection with the anode fixture 34 and the electrolyte 20, wherein one 36 of the two parallel branches 36 and 38 includes the primary electroplating anode 14, and wherein the other 38 of the two parallel branches 34 and 36 includes in series connection the auxiliary electroplating anode 16 and the resistor 18. Another step includes applying a voltage across the turbine nozzle doublet 22 and the anode fixture 34. In one example, the auxiliary electroplating anode 16 is a conforming anode.

In one modification of the second method, the resistor 18 is a variable resistor. In one variation, there is also included repeating the above-described steps of the second method for additional turbine nozzle doublets 22 for various values of resistance of the variable resistor. In one extension of this variation, there is also included the step of choosing one of the various values of resistance which substantially increases platinum deposition on inter-airfoil-facing surfaces of the two airfoils 24 and 26 over that in the absence of the resistor 18 and which avoids any substantial deposited platinum blistering. In one option, the resistance of the variable resistor is set at the chosen one of the various values of resistance, and the steps of the second method are thereafter repeated for electroplating other turbine nozzle doublets 22. In a different modification of the second method, the resistor 18 is a fixed resistor having a resistance chosen which substantially increases platinum deposition on inter-airfoil-facing surfaces of the two airfoils 24 and 26 over that in the absence of the resistor 18 and which avoids any substantial deposited platinum blistering.

It is noted that the previously-described enablements, examples, modifications, etc. of any of the methods and expressions of the embodiment of FIGS. 1-2 are equally applicable to any one or more or all of the other of the methods and expressions of the embodiment of FIGS. 1-2. In any one or more or all of the previously-described methods and expressions of an embodiment of the invention, there is included a cathode fixture 40 and a rectifier 42. In one arrangement, the cathode fixture 40 supports, and is electrically connected to the workpiece 12 (such as the turbine nozzle doublet 22). In one variation, the rectifier 42 is electrically connected to the anode fixture 34 and the cathode fixture 40. In one modification, the direction of electric current is as shown by arrow 44 in FIG. 1. In one employment, the primary electroplating anode 14 has a shape of a flat screen. In one application, additional primary and secondary electroplating anodes are employed such as, without limitation, when electroplating several workpieces at one time.

Applicants performed a first set of experiments electroplating a turbine nozzle doublet 22 having a surface area of substantially 206 square centimeters using an electrolyte 20 consisting essentially of Pt(NH₃)₄HPO₄, using a primary electroplating anode 14 having a surface area of substantially 290 square centimeters, and using an auxiliary electroplating anode 16 including an anode mesh portion having a surface area of generally 3.2 square centimeters. When all of the current was allowed to pass only through the primary electroplating anode 14, not enough platinum was deposited between the airfoils 24 and 26. When all of the current was allowed to pass only through the auxiliary electroplating anode 16, the result was anode polarization and no plating. When equal current was allowed to pass through the primary and auxiliary electroplating anodes 14 and 16, too much platinum was deposited between the airfoils 24 and 26.

Applicants performed a second set of experiments similar to the first set wherein a 0-5000 ohm variable resistor was employed, wherein the voltage VA between the turbine nozzle doublet 22 and the auxiliary electroplating anode 16 was measured, and wherein the voltage VP between the turbine nozzle doublet 22 and the primary electroplating anode 14 was measured. In one trial, with VP=VA=2.2 volts dc (direct current), platinum blisters were observed between the airfoils 24 and 26. In another trial, with VP=2.3 volts and VA=1.0 volts, no blisters were observed between the airfoils but only a thin layer of platinum was deposited between the airfoils. In another trial with VP=2.3 volts and VA=1.6 volts, no blisters were observed between the airfoils and a slightly thicker layer of platinum was deposited between the airfoils. In another trial, with VP=1.7 volts and VA=1.7 volts, no blisters were observed between the airfoils and an acceptable layer of platinum was deposited between the airfoils. It is noted that, in one option, the variable resistor would be replaced with a fixed resistor for production electroplating of the turbine nozzle doublets 22.

While the present invention has been illustrated by a description of several methods and expressions of an embodiment, it is not the intention of the applicants to restrict or limit the spirit and scope of the appended claims to such detail. Numerous other variations, changes, and substitutions will occur to those skilled in the art without departing from the scope of the invention.

1. Apparatus for electroplating a workpiece comprising:
a) a primary electroplating anode;
b) an auxiliary electroplating anode; and
c) a resistor electrically connected in series to one of the primary and auxiliary electroplating anodes, wherein the primary and auxiliary electroplating anodes are electrically connectable in parallel to an electrolyte.

2. The apparatus of claim 1, wherein the resistor is connected in series to the auxiliary electroplating anode.

3. The apparatus of claim 1, wherein the workpiece has a workpiece shape and wherein the auxiliary electroplating anode has an auxiliary-anode shape which conforms at least in part to the workpiece shape.

4. The apparatus of claim 3, wherein the workpiece is a turbine nozzle doublet having two airfoils and having an inner band and an outer band each connecting together the two airfoils.

5. The apparatus of claim 1, wherein the resistor is a variable resistor.

6. The apparatus of claim 1, wherein the resistor is a fixed resistor.

7. Apparatus for electroplating a turbine nozzle doublet having two airfoils and having an inner band and an outer band each connecting together the two airfoils comprising:
a) a primary electroplating anode disposable outward of the two airfoils;
b) an auxiliary electroplating anode having at least a portion which is disposable between the two airfoils; and
c) a resistor electrically connected in series to the auxiliary electroplating anode, wherein the primary and auxiliary electroplating anodes are electrically connectable in parallel to an electrolyte.

8. The apparatus of claim 7, wherein the electrolyte consists essentially of Pt(NH₃)₄HPO₄ and is disposed in contact with the two airfoils and with the primary and auxiliary electroplating anodes.

9. The apparatus of claim 8, wherein the resistor is a variable resistor.

10. The apparatus of claim 8, wherein the resistor is a fixed resistor having a resistance chosen to substantially increase platinum deposition on inter-airfoil-facing surfaces of the two airfoils over that in the absence of the resistor and to avoid any substantial deposited platinum blistering.

11. A method for electroplating a workpiece comprising the steps of:
a) obtaining an electrolyte, a primary electroplating anode, and an auxiliary electroplating anode;
b) disposing the workpiece and the primary and auxiliary electroplating anodes in contact with the electrolyte; and
c) applying electric current through the primary electroplating anode at a first amperage and through the auxiliary electroplating anode at a different second amperage.

12. The method of claim 11, wherein the workpiece includes two spaced apart workpiece portions, wherein the primary electroplating anode is disposed outward of the two spaced-apart workpiece portions, and wherein the auxiliary electroplating anode has at least a portion which is disposed between the two spaced-apart workpiece portions.

13. The method of claim 12, wherein the electrolyte consists essentially of Pt(NH₃)₄HPO₄.

14. The method of claim 13, wherein the second amperage is chosen to substantially increase platinum deposition on areas of the workpiece between the two spaced-apart workpiece portions over that of equal first and second amperages and is chosen to substantially avoid deposited platinum blistering.

15. The method of claim 14, wherein the workpiece is a turbine nozzle doublet having two airfoils and having an inner band and an outer band each connecting together the two airfoils.

16. A method for electroplating a turbine nozzle doublet having two airfoils and having an inner band and an outer band each connecting together the two airfoils comprising the steps of:
a) obtaining an electrolyte consisting essentially of Pt(NH₃)₄HPO₄;
b) obtaining a primary electroplating anode, an auxiliary electroplating anode, a resistor, and an anode fixture;
c) disposing the two airfoils and the primary and auxiliary electroplating anodes in contact with the electrolyte;
d) creating a circuit having two branches in parallel electrical connection with the anode fixture and the electrolyte, wherein one of the two parallel branches includes the primary electroplating anode, and wherein the other of the two parallel branches includes in series connection the auxiliary electroplating anode and the resistor; and
e) applying a voltage across the turbine nozzle doublet and the anode fixture.

17. The method of claim 16, wherein the resistor is a variable resistor and including repeating steps a) through e) for additional turbine nozzle doublets for various values of resistance of the variable resistor.

18. The method of claim 17, including the step of choosing one of the various values of resistance which substantially increases platinum deposition on inter-airfoil-facing surfaces of the two airfoils over that in the absence of the resistor and which avoids any substantial deposited platinum blistering.

19. The method of claim 16, wherein the resistor is a fixed resistor having a resistance chosen which substantially increases platinum deposition on inter-airfoil-facing surfaces of the two airfoils over that in the absence of the resistor and which avoids any substantial deposited platinum blistering.

20. The method of claim 16, wherein the auxiliary electroplating anode is a conforming anode.
